(19) United States
(12) Patent Application Publication
(10) Pub. No.: US 2004/0121680 A1
(43) Pub. Date: Jun. 24, 2004

(54) Compositions and methods for treating lofty nonwoven substrates

(75) Inventors: Ali Yahiaoui, Roswell, GA (US); Eric Scott Kepner, Alpharetta, GA (US); Leonard Eugene Zelazoski, Kennesaw, GA (US); Chad Michael Freese, Martinez, CA (US)

Correspondence Address: KIMBERLY-CLARK WORLDWIDE, INC., 401 NORTH LAKE STREET, NEENAH, WI, 54956

(73) Assignee: Kimberly-Clark Worldwide, Inc.

(21) Appl. No.: 10/327,828

(22) Filed: Dec. 23, 2002

(51) Int. Cl. B32B 27/16; B32B 27/02

(52) U.S. Cl. 442/118; 442/76; 442/164

(57) ABSTRACT

A treatment composition and a method for treating substrates that includes contacting at least a portion of the substrate with an aqueous treatment that includes from about 50 weight percent to about 95 weight percent of water; and at least about 5 weight percent of a mixture of additives that includes from about 4 parts to about 8 parts of a first additive that is a blend of ethoxylated hydrogenated castor oil and sorbitan monooleate; from about 1 to about 3 parts of a second additive that is an alkyl polyglycoside or a derivative of an alkyl polyglycoside; and from about 1 to about 3 parts of a third additive that is an ethoxylated polyalkyl siloxane.

### FIELD

The present invention is directed to treatment compositions and methods for treating fibers, nonwoven fabrics and other substrates.

### BACKGROUND

Polymers are used extensively to make a variety of products which include blown and cast films, extruded sheets, injection molded articles, foams, blow molded articles, extruded pipe, monofilaments, fibers and nonwoven webs. Some polymers, such as polyolefins, are naturally hydrophobic, and for many uses this property is a disadvantage. There are a number of uses for polymers where their hydrophobic nature either limits their usefulness or requires some effort to modify the surface characteristics of the shaped articles made therefrom. By way of example, polyolefins, such as polyethylene and polypropylene, are used to manufacture polymeric fabrics which are employed in the construction of such disposable absorbent articles as diapers, feminine care products, incontinence products, training pants, wipes, and so forth. Such polymeric fabrics often are nonwoven webs prepared by, for example, such processes as melt-blowing, carding, coforming and spunbonding. Frequently, such polymeric fabrics need to be wettable by water or aqueous-based liquids. Wettability can be obtained by spraying or otherwise coating (i.e., surface treating or topically treating) the fabric with a surfactant solution during or after its formation, and then drying the web.

Water-absorbent articles, especially personal care absorbent articles, such as diapers, training pants, sanitary napkins and incontinence products, typically include at least one nonwoven polymeric fabric. As surge diaper layer (i.e. layer used under the liner and not in direct contact with skin), for example, the nonwoven fabric provides rapid acquisition, adequate retention, and efficient distribution of a fluid such as water or an aqueous solution. However, polyolefin nonwoven fabrics and other types of polymeric fabrics are normally hydrophobic and are water-repellent. Thus, to effectively absorb water the polymeric fabrics must be treated to become hydrophilic. In addition, it is desirable that the hydrophilic treatment promotes a dryer environment by reducing and controlling moisture dampness in an enclosed or occlusive environment as during diaper wear. Skin moisture is a major source of skin health problems associated with the use of diapers that do not effectively maintain a dry environment at the material/skin interface. Accordingly, there is a need to improve the hydrophilicity or wettability of fibers, nonwoven fabrics and other substrates and to impart superior absorbent functions to a diaper and, desirably, promote a dryer environment within a diaper, particularly to substrates in a diaper that will be used not in direct contact to the skin of a wearer.

### SUMMARY OF THE INVENTION

The present invention provides an aqueous treatment composition for imparting wettability to a substrate that comprises from about 50 weight percent to about 95 weight percent of water and at least about 5 weight percent of a mixture of additives that includes: from about 4 parts to about 10 parts by weight of a first additive that includes a blend of ethoxylated hydrogenated castor oil and sorbitan monooleate; from about 1 to about 4 parts by weight of a second additive that is an alkyl polyglycoside or a derivative of an alkyl polyglycoside; and from about 1 to about 4 parts by weight of a third additive that is an ethoxylated polyalkyl siloxane. The aqueous treatment composition may include from about 70 weight percent to about 95 weight percent of water. The aqueous treatment composition may include at least about 7 weight percent of the mixture of additives. In one embodiment, the aqueous treatment composition includes a mixture of additives that comprises from about 4 parts to about 8 parts by weight of the first additive; from about 1 to about 3 parts by weight of the second additive; and from about 1 to about 3 parts by weight of the third additive. In another embodiment, the aqueous treatment composition includes a mixture of additives that comprises from about 2 to about 4 parts by weight by weight of the first additive, from about 1 to about 2 parts of the second additive and about 1 part by weight of the third additive. In yet another embodiment, the aqueous treatment composition includes a mixture of additives that comprises about 3 parts by weight of the first additive, about 1 part by weight of the second additive and about 1 part by weight of the third additive. In one embodiment, the alkyl polyglycoside or the derivative of an alkyl polyglycoside is an octylpolyglycoside. The aqueous treatment composition may be applied to the substrate as a foamed treatment.

The present invention further provides an aqueous treatment composition for a substrate, the aqueous treatment composition that includes: from about 70 weight percent to about 95 weight percent of water; from about 1.5 weight percent to about 15 weight percent of sorbitan monooleate; from about 1 weight percent to about 10 weight percent of an ethoxylated, hydrogenated castor oil; from about 0.5 weight percent to about 5 weight percent of an alkyl polyglycoside or a derivative of an alkyl polyglycoside; and from about 1 weight percent to about 10 weight percent of an ethoxylated polyalkyl siloxane. The aqueous treatment composition may include from about 80 weight percent to about 95 weight percent of water. In another embodiment, the aqueous treatment composition includes at least about 3 weight percent of sorbitan monooleate, at least about 2 weight percent of the ethoxylated, hydrogenated castor oil, at least about 1 weight percent of the alkyl polyglycoside, and at least about 2 weight percent of the ethoxylated polyalkyl siloxane. In yet another embodiment, the aqueous treatment composition includes from about 80 weight percent to about 95 weight percent of water; from about 2 weight percent to about 10 weight percent of sorbitan monooleate; from about 1.5 weight percent to about 10 weight percent of an ethoxylated, hydrogenated castor oil; from about 0.75 weight percent to about 5 weight percent of an alkyl polyglycoside or a derivative of an alkyl polyglycoside; and from about 1 weight percent to about 5 weight percent of an ethoxylated polyalkyl siloxane.

The present invention also provides fibers having a surface treated with a surfactant mixture comprising an ethoxylated, hydrogenated castor oil; sorbitan monooleate; an ethoxylated polyalkyl siloxane; and an alkyl polyglycoside or a derivative of an alkyl polyglycoside. The fibers may be or include multicomponent fibers. The multicomponent fibers may be or include bicomponent fibers, for example, bicomponent fibers including a polyethylene component and a polypropylene component in a side-by-side configuration. The present invention also provides porous thermoplastic substrates treated with an ethoxylated, hydrogenated castor oil; sorbitan monooleate; an ethoxylated polyalkyl siloxane; and an alkyl polyglycoside or a derivative of an alkyl polyglycoside. The porous thermoplastic substrate may be a lofty nonwoven fabric and the lofty nonwoven fabric may include multicomponent fibers, for example bicomponent fibers such as bicomponent fibers that include a polyethylene component and a polypropylene component in a side-by-side configuration. The present invention also includes personal care articles, health care articles and absorbent articles that include such thermoplastic substrates.

The present invention also provides methods of treating a nonwoven substrate that include contacting a substrate with a composition that includes a mixture of additives comprising: from about 2 parts to about 10 parts by weight of an ethoxylated, hydrogenated castor oil; from about 2 parts to about 10 parts by weight of sorbitan monooleate; from about 1 part to about 5 parts by weight of a an alkyl polyglycoside or a derivative of an alkyl polyglycoside; and from about 1 part to about 10 parts by weight of an ethoxylated polyalkyl siloxane. The mixture of additives may be included in an aqueous treatment composition that comprises from about 50 weight percent to about 95 weight percent of water or from about 80 weight percent to about 90 weight percent of water. In one embodiment, the method includes a mixture of additives that comprises: from about 3 parts to about 6 parts by weight of an ethoxylated, hydrogenated castor oil; from about 2 parts to about 5 parts by weight of sorbitan monooleate; from about 1 part to about 2 parts by weight of an alkyl polyglycoside or a derivative of an alkyl polyglycoside; and from about 1 parts to about 4 parts by weight of an ethoxylated polyalkyl siloxane. In another embodiment, the method includes a mixture of additives that comprises: from about 3 parts to about 6 parts by weight of an ethoxylated, hydrogenated castor oil; from about 2.5 parts to about 5 parts by weight of sorbitan monooleate; from about 1 part to about 2 parts by weight of an alkyl polyglycoside or a derivative of an alkyl polyglycoside; and from about 2 parts to about 4 parts by weight of an ethoxylated polyalkyl siloxane.

The present invention also provides a method of enhanced fluid handling properties to a lofty bicomponent nonwoven substrate, the method including contacting a lofty bicomponent nonwoven substrate with an aqueous treatment composition that comprises: from about 50 weight percent to about 95 weight percent of water; from about 1.5 weight percent to about 20 weight percent of sorbitan monooleate; from about 1.5 weight percent to about 15 weight percent of an ethoxylated, hydrogenated castor oil; from about 0.75 weight percent to about 7.5 weight percent of an alkyl polyglycoside or a derivative of an alkyl polyglycoside; and from about 1 weight percent to about 10 weight percent of an ethoxylated polyalkyl siloxane. In one embodiment, the method includes an aqueous treatment composition that comprises from about 80 weight percent to about 95 weight percent of water; from about 1.5 weight percent to about 6 weight percent of sorbitan monooleate; from about 1.5 weight percent to about 6 weight percent of an ethoxylated, hydrogenated castor oil; from about 0.75 weight percent to about 3 weight percent of an alkyl polyglycoside or a derivative of an alkyl polyglycoside; and from about 1 weight percent to about 5 weight percent of an ethoxylated polyalkyl siloxane. The aqueous treatment composition may be applied as a foam. The aqueous treatment may also be applied uniformly to the lofty bicomponent nonwoven substrate so that a durable hydrophilic character is imparted to the lofty bicomponent nonwoven substrate or the aqueous treatment is applied to one side of the lofty bicomponent nonwoven substrate. In one embodiment of the method, the aqueous treatment is applied to one side of the lofty bicomponent nonwoven substrate and the treatment is distributed over the substrate by applying a vacuum on the opposite side of the substrate or by nipping the substrate. In another embodiment of the method, the aqueous treatment is applied to both sides of the lofty bicomponent nonwoven substrate. In yet another embodiment of the method, the aqueous treatment is applied to both sides of the lofty bicomponent nonwoven substrate and the treatment is distributed over the substrate by applying a vacuum on the one or both sides of the substrate or by nipping the substrate.

### BRIEF DESCRIPTION OF THE DRAWINGS

FIG. 1 illustrates an exemplary process for application of a treatment composition to a substrate.

FIG. 2 illustrates an exemplary dip and squeeze method of applying a treatment composition to a nonwoven fabric.

FIG. 3 schematically illustrates an exemplary foam treatment application system that provides zoned or full width application.

FIG. 4 illustrates an exemplary zoned treatment application apparatus and system.

FIG. 5 illustrates a partially cutaway, top plan view of an exemplary absorbent article.

FIG. 6 illustrates a sectional view of the absorbent article of FIG. 5 taken along line 6-6.

FIG. 7 illustrates yet another exemplary process for application of a treatment composition to a substrate.

### DETAILED DESCRIPTION

The present invention provides a composition and a method for treating fibers, fabrics or other substrates which impart a hydrophilic character to the substrates. The compositions and methods disclosed herein are useful for treating synthetic and natural fibers and substrates and are particularly useful for treating hydrophobic fibers and porous hydrophobic polymer substrates. In a desirable embodiment, a nonwoven web is treated with compositions and methods of the present invention to improve wettability, absorbency and the fluid intake ability of the web. When the treated nonwoven web is used as an acquisition or surge layer in a diaper, the treated nonwoven web promotes skin dryness. In a diaper, the surge layer is located between the body side liner and the absorbent.

As used herein, the term “porous hydrophobic polymer substrate” is meant to include any shaped article, provided it is porous and composed, in whole or in part, of a hydrophobic polymer. For example, the substrate may be a sheet-like material, such as a sheet of a foamed material. The sheet-like material also may be a fibrous web, such as a woven or nonwoven fabric or web. The substrate also may be a hydrophobic polymer fiber, per se, or hydrophobic polymer fibers which have been formed into a fibrous web. The fibrous web desirably will be a nonwoven web, such as, but not limited to, a meltblown web, a spunbonded web, a carded web or an airlaid web. The substrate also may be a laminate of two or more layers of a sheet-like material. For example, the layers may be independently selected from the group consisting of meltblown webs and spunbonded webs. However, other sheet-like materials such as films or foams may be used in addition to, or instead of, meltblown and spunbonded webs. In addition, the layers of the laminate may be prepared from the same hydrophobic polymer or different hydrophobic polymers.

The porous hydrophobic substrate includes hydrophobic nonwovens that may include natural fibers as well as synthetic fibers. According to one desirable embodiment of the present invention, the fibers of the substrate are substantially uniformly coated with a hydrophilic treatment. As an example, a nonwoven fabric made from hydrophobic synthetic fibers, such as polyolefin fibers, is treated with a composition and a method of the present invention to provide a wettable, polyolefin nonwoven fabric. The polyolefin fibers that form the fabric may include polyethylene and/or polypropylene fibers and fibers produced from compositions and blends that include a polyethylene and/or a polypropylene resin and can be produced by various known methods.

The hydrophobic polymer fibers and/or nonwoven substrate generally may be prepared by any known means. As a practical matter, however, the fibers usually will be prepared by a melt-extrusion process and formed into a fibrous web, such as a nonwoven web. The term “melt-extrusion process” as applied to a nonwoven web is meant to include a nonwoven web prepared by any melt-extrusion process for forming a nonwoven web in which melt-extrusion to form fibers is followed by web formation, typically concurrently, on a porous support. The term includes, among others, such well-known processes as meltblowing, coforming, spunbonding, and so forth. By way of illustration only, such processes are exemplified by the following references: meltblowing references include, by way of example, U.S. Pat. No. 3,016,599 to R. W. Perry, Jr., U.S. Pat. No. 3,704,198 to J. S. Prentice, U.S. Pat. No. 3,755,527 to J. P. Keller et al., U.S. Pat. No. 3,849,241 to R. R. Buntin et al., U.S. Pat. No. 3,978,185 to R. R. Buntin et al., and U.S. Pat. No. 4,663,220 to T. J. Wisneski et al. See, also, V. A. Wente, “Superfine Thermoplastic Fibers”, Industrial and Engineering Chemistry, Vol. 48, No. 8, pp.1342-1346 (1956); V. A. Wente et al., “Manufacture of Superfine Organic Fibers”, Navy Research Laboratory, Washington, D.C., NRL Report 4364 (111437), dated May 25, 1954, United States Department of Commerce, Office of Technical Services; and Robert R. Buntin and Dwight T. Lohkamp, “Melt Blowing—A One-Step Web Process for New Nonwoven Products”, Journal of the Technical Association of the Pulp and Paper Industry, Vol. 56, No.4, pp. 74-77 (1973); coforming references include U.S. Pat. No. 4,100,324 to R. A. Anderson et al. and U.S. Pat. No. 4,118,531 to E. R. Hauser; and spunbonding references include, among others, U.S. Pat. No. 3,341,394 to Kinney, U.S. Pat. No. 3,655,862 to Dorschner et al., U.S. Pat. No. 3,692,618 to Dorschner et al., U.S. Pat. No. 3,705,068 to Dobo et al., U.S. Pat. No. 3,802,817 to Matsuki et al., U.S. Pat. No. 3,853,651 to Porte, U.S. Pat. No. 4,064,605 to Akiyama et al., U.S. Pat. No. 4,091,140 to Harmon, U.S. Pat. No. 4,100,319 to Schwartz, U.S. Pat. No. 4,340,563 to Appel and Morman, U.S. Pat. No. 4,405,297 to Appel and Morman, U.S. Pat. No. 4,434,204 to Hartman et al., U.S. Pat. No. 4,627,811 to Greiser and Wagner, and U.S. Pat. No. 4,644,045 to Fowells.

Other methods for preparing nonwoven webs are, of course, known and may be employed. Such methods include air laying, wet laying, carding, and so forth. In some cases it may be either desirable or necessary to stabilize the nonwoven web by known means, such as thermal point bonding, through-air bonding, and hydroentangling. In addition to nonwoven webs, the hydrophobic polymer fibers may be in the form of continuous filaments or staple fibers, as well as woven or knitted fabrics prepared from such continuous filaments or staple fibers. Furthermore, the nonwoven web may include bicomponent or other multicomponent fibers. Exemplary multicomponent nonwoven webs are described in U.S. Pat. No. 5,382,400 issued to Pike et al., U.S. patent application Ser. No. 10/037,467 entitled “High Loft Low Density Nonwoven Webs Of Crimped Filaments And Methods Of Making Same” and U.S. patent application Ser. No. 10/136,702 entitled “Methods For Making Nonwoven Materials On A Surface Having Surface Features And Nonwoven Materials Having Surface Features” which are hereby incorporated by reference herein in their entirety. Sheath/core bicomponent fibers where the sheath is a polyolefin such as polyethylene or polypropylene and the core is polyester such as poly(ethylene terephthalate) or poly(butylene terephthalate) can also be used to produce carded webs or spunbonded webs. The primary role of the polyester core is to provide resiliency and thus to maintain or recover bulk under/after load. Bulk retention and recovery plays a role in separation of the skin from the absorbent structure. This separation has shown an effect on skin dryness. The combination of skin separation provided with a resilient structure along with a treatment such of the present invention can provide an overall more efficient material for fluid handling and skin dryness purposes.

The term “hydrophobic polymer” is used herein to mean any polymer resistant to wetting, or not readily wet, by water, i.e., having a lack of affinity for water. Examples of hydrophobic polymers include, by way of illustration only, polyolefins, such as polyethylene, poly(isobutene), poly(isoprene), poly(4-methyl-1-pentene), polypropylene, ethylene-propylene copolymers, ethylene-propylene-hexadiene copolymers, and ethylene-vinyl acetate copolymers; styrene polymers, such as poly(styrene), poly(2-methylstyrene), styrene-acrylonitrile copolymers having less than about 20 mole-percent acrylonitrile, and styrene-2,2,3,3,-tetrafluoropropyl methacrylate copolymers; halogenated hydrocarbon polymers, such as poly(chlorotrifluoroethylene), chlorotrifluoroethylene-tetrafluoroethylene copolymers, poly(hexafluoropropylene), poly(tetrafluoroethylene), tetrafluoroethylene-ethylene copolymers, poly(trifluoroethylene), poly(vinyl fluoride), and poly(vinylidene fluoride); vinyl polymers, such as poly(vinyl butyrate), poly(vinyl decanoate), poly(vinyl dodecanoate), poly(vinyl hexadecanoate), poly(vinyl hexanoate), poly(vinyl propionate), poly(vinyl octanoate), poly(heptafluoroisopropoxyethylene), poly(heptafluoroisopropoxypropylene), and poly(methacrylonitrile); acrylic polymers, such as poly(n-butyl acetate), poly(ethyl acrylate), poly[(1-chlorodifluoromethyl)tetrafluoroethyl acrylate], poly[di(chlorofluoromethyl)fluoromethyl acrylate], poly(1,1-dihydroheptafluorobutyl acrylate), poly(1,1-dihydropentafluoroisopropyl acrylate), poly(1,1-dihydropentadecafluorooctyl acrylate), poly(heptafluoroisopropyl acrylate), poly[5-(heptafluoroisopropoxy)pentyl acrylate], poly[11-(heptafluoroisopropoxy)undecyl acrylate], poly[2-(heptafluoropropoxy)ethyl acrylate], and poly(nonafluoroisobutyl acrylate); methacrylic polymers, such as poly(benzyl methacrylate), poly(n-butyl methacrylate), poly(isobutyl methacrylate), poly(t-butyl methacrylate), poly(t-butylaminoethyl methacrylate), poly(dodecyl methacrylate), poly(ethyl methacrylate), poly(2-ethylhexyl methacrylate), poly(n-hexyl methacrylate), poly(phenyl methacrylate), poly(n-propyl methacrylate), poly(octadecyl methacrylate), poly(1,1-dihydropentadecafluorooctyl methacrylate), poly(heptafluoroisopropyl methacrylate), poly(heptadecafluorooctyl methacrylate), poly(1-hydrotetrafluoroethyl methacrylate), poly(1,1-dihydrotetrafluoropropyl methacrylate), poly(1-hydrohexafluoroisopropyl methacrylate), and poly(t-nonafluorobutyl methacrylate); and polyesters, such a poly(ethylene terephthalate) and poly(butylene terephthalate).

The term “polyolefin” is used herein to mean a polymer prepared by the addition polymerization of one or more unsaturated monomers which contain only carbon and hydrogen atoms. Examples of such polyolefins include polyethylene, polypropylene, poly(1-butene), poly(2-butene), poly(1-pentene), poly(2-pentene), poly(3-methyl-1-pentene), poly(4-methyl-1-pentene), and so forth. In addition, such term is meant to include blends of two or more polyolefins and random and block copolymers prepared from two or more different unsaturated monomers. Because of their commercial importance, the most desired polyolefins are polyethylene and polypropylene. The polyolefin may contain additives as is known or customary in the art. For example, the polyolefin may contain pigments, opacifiers, fillers, delustrants, antioxidants, antistatic agents, stabilizers, oxygen scavengers, and so forth.

It is desirable that fibers and/or substrates are imparted with a durable hydrophilic treatment so that the fibers and substrates can be used in absorbent, personal care products and other disposable, absorbent products. The term “durable” as used herein with reference to a coating of a hydrophilic polymeric is material on a fiber or other substrate means that the coated porous substrate remains wettable after multiple exposures to an aqueous medium, such as water, saline, urine, and other body fluids. One procedure for evaluating durability when the porous substrate is a fibrous web is a modified run-off test followed by washing and drying (a wash/dry cycle). The fibrous web typically can remain wettable for at least three and even five cycles of exposing, washing, and drying.

The treatment composition of the present invention includes at least three components. One of the components is an alkyl polyglycoside or a derivative of an alkyl polyglycoside. Suggested alkyl polyglycosides include, but are not limited to, alkyl polyglycosides having 8 to 10 carbons in the alkyl chain. A particular suggested alkyl polyglycoside is an alkyl polyglycoside having 8 carbon atoms in the alkyl chain, an octylpolyglycoside. A commercially example of such an octylpolyglycoside includes, but is not limited to, GLUCOPON 220 UP which is provided in an aqueous solution of 60 weight percent of an octylpolyglycoside having the following chemical formula where x is selected from the group of integers 0, 1, 2 and 3. GLUCOPON 220 UP (also referred to as “GLUCOPON”) is commercially available from Cognis Corporation of Ambler, Pa.

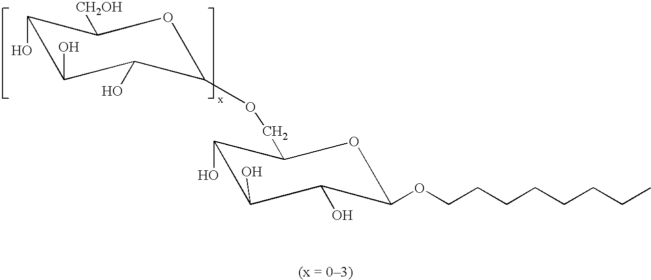

The second, and desirably the largest, component of the treatment compositions of the present invention is a mixture of a hydrogenated, ethoxylated castor oil and sorbitan monooleate. A suggested example of a commercially available example of a mixture of a hydrogenated, ethoxylated castor oil and sorbitan monooleate includes, but is not limited to, a surfactant mixture sold under the tradename AHCOVEL Base N-62. AHCOVEL Base N-62 (also referred to simply as “AHCOVEL”) is a blend of a hydrogenated, ethoxylated castor oil and sorbitan monooleate that is provided in about a mixture of about a 1:1 ratio (more

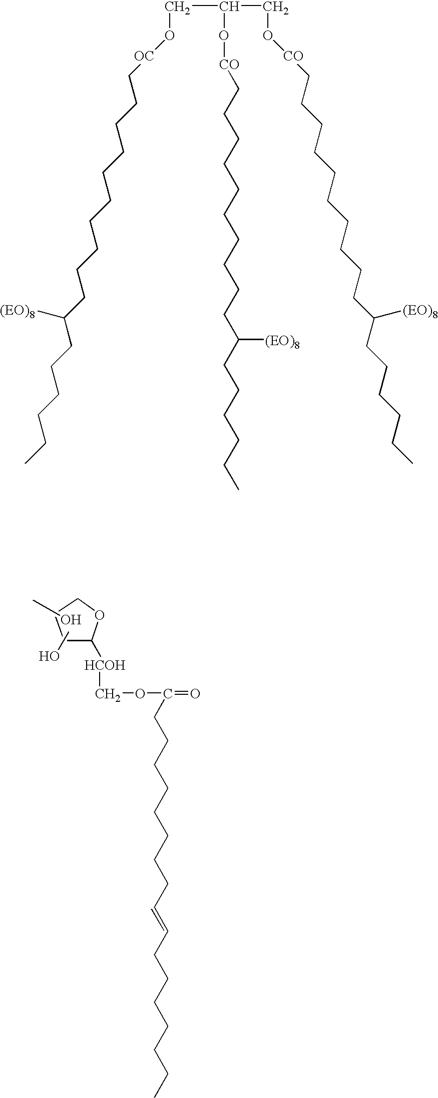

specifically 55 percent sorbitan monooleate and 45 percent hydrogenated, ethoxylated castor oil). AHCOVEL Base N-62 can be obtained from Uniqema a division of ICI having offices in New Castle, Del.

The third component is a siloxane polyether, more desirably an ethoxylated polyalkyl siloxane. Suggested examples of ethoxylated polyalkyl siloxane, include, but are not limited to, polyethylene glycol-grafted trisiloxane of the following chemical formula:

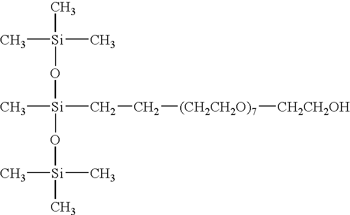

A suggested commercially available example of an ethoxylated polyalkyl siloxane suitable for treatment compositions of the present invention includes but, is not limited to, MASIL SF-19 siloxane polyether available form BASF of Gurnee Ill. MASIL SF-19 is a polyethylene glycol-grafted-trisiloxane of the above chemical formula.

Advantageously, the components of the treatment composition may be combined with water and can be applied in an aqueous formulation and, thus, undesirable solvents can be avoided. Treatment compositions of the present invention may further include additional, optional components. It is suggested that the three components are combined and applied in an aqueous composition that includes from about 50 weight percent to about 95 weight percent of water and at least about 5 weight percent of a mixture of additives that includes: from about 4 parts to about 10 parts by weight of a first additive that includes a blend of ethoxylated hydrogenated castor oil and sorbitan monooleate; from about 1 to about 4 parts by weight of a second additive that is an alkyl polyglycoside or a derivative of an alkyl polyglycoside; and from about 1 to about 4 parts by weight of a third additive that is an ethoxylated polyalkyl siloxane. The aqueous treatment composition may include from about 70 weight percent to about 95 weight percent of water. The aqueous treatment composition may include at least about 7 weight percent of the mixture of additives. In one embodiment, the aqueous treatment composition includes a mixture of additives that comprises from about 4 parts to about 8 parts by weight of the first additive; from about 1 to about 3 parts by weight of the second additive; and from about 1 to about 3 parts by weight of the third additive. In another embodiment, the aqueous treatment composition includes a mixture of additives that comprises from about 2 to about 4 parts by weight of the first additive, from about 1 to about 2 parts by weight of the second additive and about 1 part by weight of the third additive. In yet another embodiment, the aqueous treatment composition includes a mixture of additives that comprises about 3 parts by weight of the first additive, about 1 part by weight of the second additive and about 1 part by weight of the third additive.

The present invention further provides an aqueous treatment composition for a substrate, the aqueous treatment composition that includes: from about 70 weight percent to about 95 weight percent of water; from about 1.5 weight percent to about 15 weight percent of sorbitan monooleate; from about 1 weight percent to about 10 weight percent of an ethoxylated, hydrogenated castor oil; from about 0.5 weight percent to about 5 weight percent of an alkyl polyglycoside or a derivative of an alkyl polyglycoside; and from about 1 weight percent to about 10 weight percent of an ethoxylated polyalkyl siloxane. The aqueous treatment composition may include from about 80 weight percent to about 95 weight percent of water. It is suggested that the aqueous treatment composition includes at least about 3 weight percent of sorbitan monooleate, at least about 2 weight percent of the ethoxylated, hydrogenated castor oil, at least about 1 weight percent of the alkyl polyglycoside, and at least about 2 weight percent of the ethoxylated polyalkyl siloxane. It is further suggested that the aqueous treatment composition includes from about 80 weight percent to about 95 weight percent of water; from about 2 weight percent to about 10 weight percent of sorbitan monooleate; from about 1.5 weight percent to about 10 weight percent of an ethoxylated, hydrogenated castor oil; from about 0.75 weight percent to about 5 weight percent of an alkyl polyglycoside or a derivative of an alkyl polyglycoside; and from about 1 weight percent to about 5 weight percent of an ethoxylated polyalkyl siloxane.

The hydrophilicity of the coating on the substrate may be uniformly applied over one or both surfaces of the substrate or may vary and can be varied in a controlled manner across at least one dimension of a porous substrate. For example, a coated porous substrate may have a central region of higher hydrophilicity which extends, for example, along the length of the substrate, with regions of lower hydrophilicity on both sides of the central region. Thus, the hydrophilicity of such a substrate would vary in a controlled manner across the width thereof. Other variations coming within the scope of the present invention will be readily apparent to those having ordinary skill in the art.

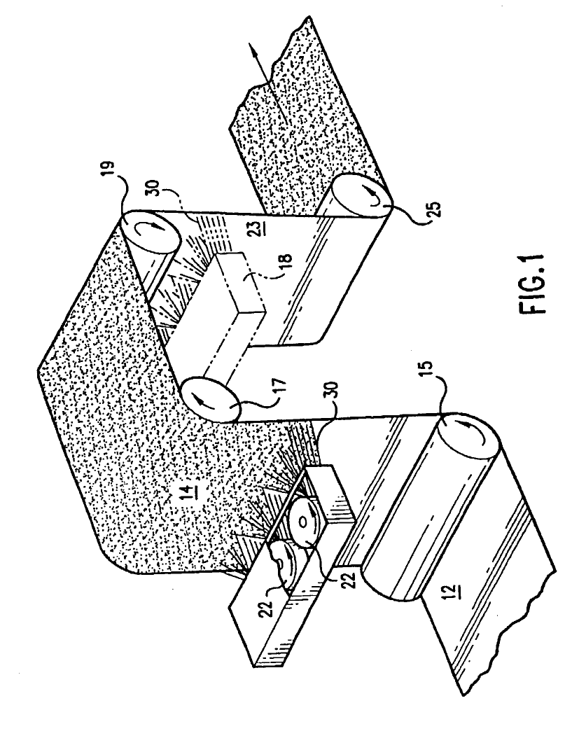

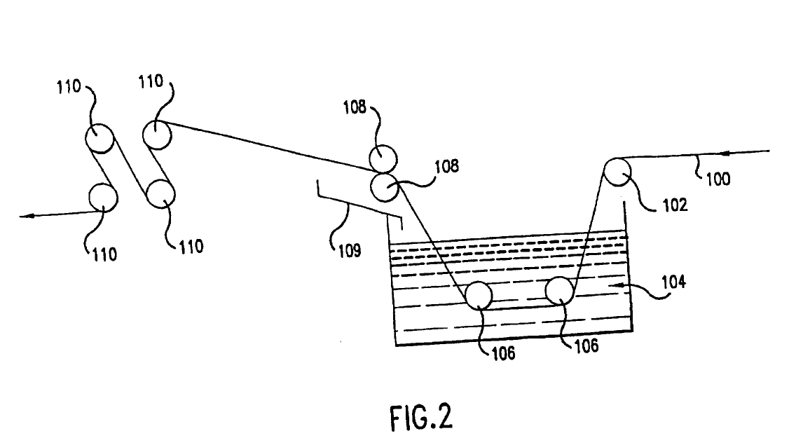

Turning now to the method for preparing a treated porous substrate, the method involves providing a porous hydrophobic polymer substrate and exposing at least a portion of the substrate to a mixture that includes at least one alkyl polyglycoside or derivative of an alkyl polyglycoside and at least one polysaccharide, modified polysaccharide, derivative of a polysaccharide or derivative of a modified polysaccharide. A suggested combination includes contacting the porous substrate with a mixture that includes an octylpolyglycoside and an ethyl hydroxyethyl cellulose. The two components, the alkyl polyglycoside and the polysaccharide, and any other optional components of the treatment composition can be applied separately or combined and may be included in water mixture and applied as an aqueous treatment. The treatment composition(s) may further include other components, such as co-surfactants, anti-foam agents, if is needed or desirable, emulsifiers, lubricants, anti-stats, skin care ingredients, anti-oxidants, vitamins, botanical extracts, scents, odor control agents, color, and anti-microbials. Exemplary methods of treating a substrate with treatment compositions are provided in the figures where FIG. 1 illustrates a first exemplary process that sprays a treatment composition on a substrate and FIG. 2 illustrates a second, exemplary “dip and squeeze” process of applying a treatment composition to a substrate.

Referring to FIG. 1, an exemplary process for applying a treatment composition of the present invention to one or both sides of a traveling web will be described. It should be appreciated by those skilled in the art that the invention is equally applicable to inline treatment or a separate, offline treatment step. Web 12, for example a spunbond or meltblown nonwoven, is directed under support roll 15 to a treating station including rotary spray heads 22 for application to one side 14 of web 12. An optional treating station 18 (shown in phantom) which includes rotary spray heads can also be used to apply the same treatment composition or another treatment composition to opposite side 23 of web 12 directed over support rolls 17 and 19. Each treatment station receives a supply of treating liquid 30 from a reservoir (not shown).

Either or both treating stations may include a rotary spray system that applies the treatment composition. This particular spray process requires the addition of an antifoam agent such as Dow Corning 2210 (Dow Corning, Inc., Midland, Mich.) at about 0.15 weight percent. An exemplary rotary spray system is illustrated in FIGS. 1, 3 and 4 illustrates an exemplary rotary spray zoned treatment application apparatus and system. A suggested system and apparatus that includes the components illustrated in the figures includes a “WEKO” system. The WEKO apparatus and system can be obtained from WEKO, Biel AG, Switzerland. The configuration includes a centrifugal damping application system using a single or double rotocarrier. The surfactant formulation is pumped to the header through a gear pump where it is fed to the damping rotors through restrictor tubes. The system is equipped with a series of rotors 50, which spin can at a speed of about 4500 rpm. Under the effect of a centrifugal force generated by the spinning rotors 50, a treatment composition can be dispensed to the nonwoven fabric or other substrate 52 in the form of an aerosol or small droplets 54. Throughput as measured in gram/minute is controlled and adjusted with is different diameter restrictor tubes, header pressure and bath parameters (e.g. concentration and temperature). Additionally, finer throughput control can be achieved by adding optional needle valves to the outlet ports of the header. If a zone treatment is desired, templates 60 made of stainless steel or another solid material of a predetermined width are placed in front of the web so that the spray is applied to the material only through the template opening(s) 62. A suggested template opening is 4 inches and provides a 4-inch wide treated zone 53 to a nonwoven material 52.

The treated web may then be dried if needed by passing over dryer cans (not shown) or other drying means and then under support roll 25 to be wound as a roll or converted to the use for which it is intended. For a polypropylene web, drying can be achieved by heating the treated web to a temperature from about 220° F. to 300° F., more desirably to a temperature from 250° F. to 290° F., by passage over a heated drum to set the treatment composition and complete drying. Drying temperatures for other polymers will be apparent to those skilled in the art. Alternative drying means include ovens, through air dryers, infrared dryers, air blowers, and so forth.

FIG. 2 illustrates an alternative arrangement and method of applying a treatment composition of the present invention. The process illustrated in FIG. 2 is refereed to as a “dip & squeeze” process. In the dip and squeeze process, the substrate is saturated with a bath containing the treating formulation, typically by immersing the substrate in the bath. The saturated material can then be nipped at a controllable pressure between two rubber rollers to remove excess saturant. Bath concentration, nip pressure and line speed are parameters that control add-on level on the fabric. Add-on level is measured by gravimetric analysis using the following equations 1 and 2.

% Wet Pick Up (WPU)=[(W_{w}−W_{d})/W_{d}]×100 (Equation 1)

and

Wt % Add-on=% WPU×C (Equation 2)

where, W_{w}=Wet weight of the substrate after saturation and nipping (grams)

W_{d}=Dry weight of treated substrate (grams)

C=bath chemical concentration (wt %)

The nip between squeeze rolls 108 removes excess treating composition which is returned to the bath by catch pan 109. Drying cans 110 remove remaining moisture. If more than one treatment composition is employed, the dip and squeeze may be repeated and the web 100 can be forwarded to and immersed in additional baths (not shown).

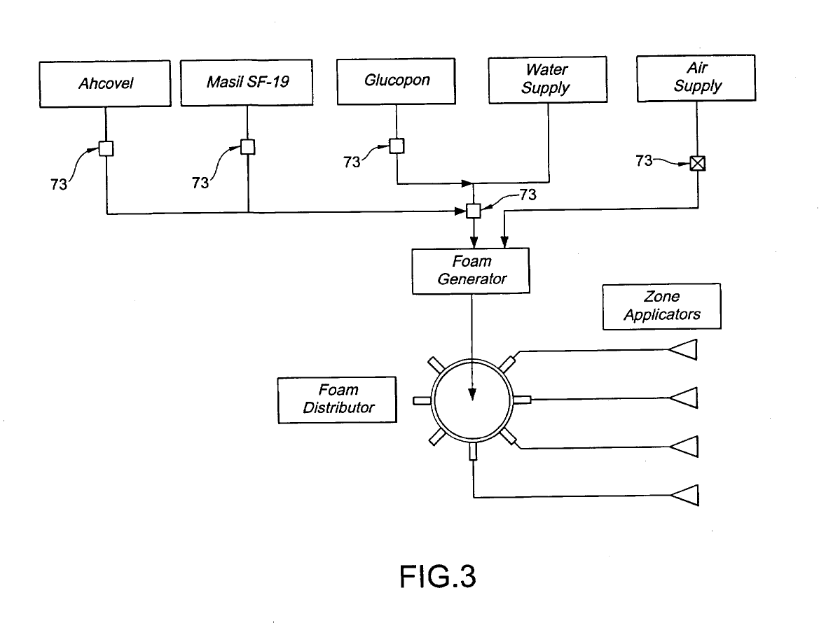

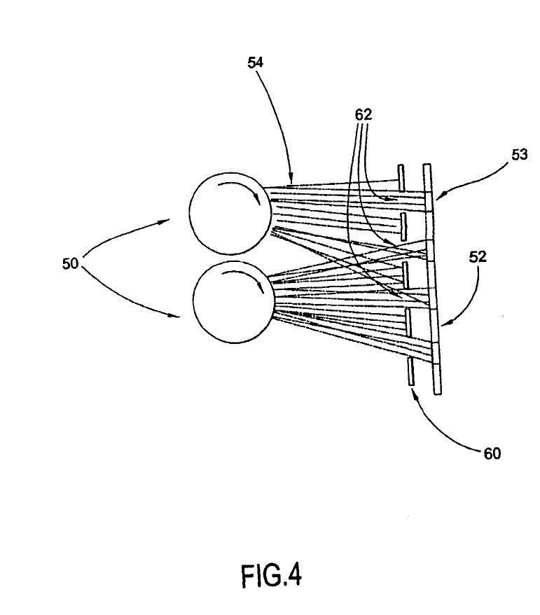

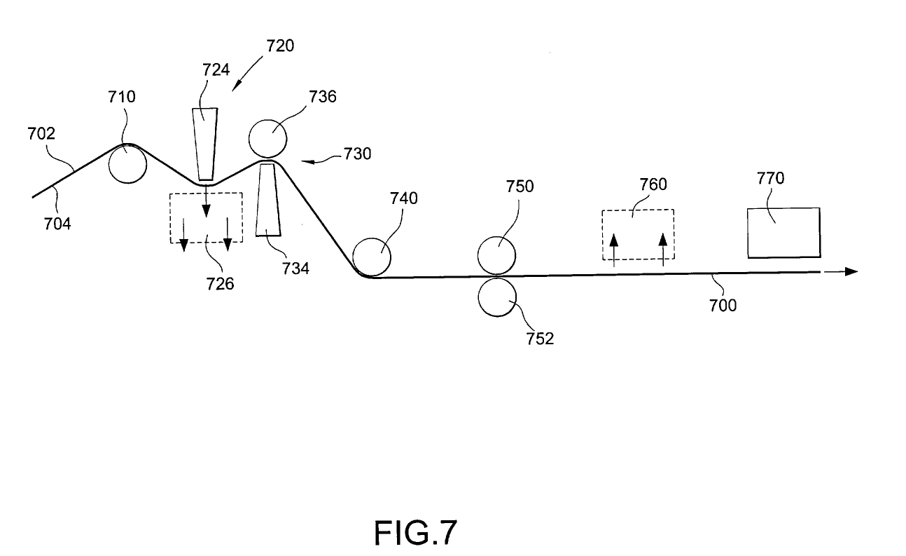

Another process that can be used to apply treatment compositions of the present invention to a substrate includes a foaming process. Foaming is a desirable process because of its chemical use efficiency, ease of operation, cleanliness, and good control over process parameters. A general schematic diagram of a foam process is shown in FIG. 3 and includes chemical tanks, air and water supplies, and metering devices (e.g. pumps, valves and flow meters) connected to a high shear-mixing chamber. Suggested foam equipment can be obtained from Gaston Systems, Incorporated of Stanley, N.C. This equipment includes a parabolic foam applicator with a ⅛ inch slot opening and a slot width that is adjustable from about 11 inches to about 18 inches, but can be as wide as 120 inches or more. This kind of foam equipment is capable of full width treatment or zone treatment. The zone treatment is achieved by using foam applicator of a specific width, e.g. 4 inches wide. In the case of zone treatment multiple 4 inch wide foam applicators can be used to simultaneously treat multiple slits of a nonwoven base roll as illustrated in FIG. 4. Desirable options for a foam treater include nipping capability over one or both foam applicators, vacuum suction below one or both foam applicators and additional nipping downstream of the foam applicators as show in FIG. 7. A combination of process settings can be selected based on foam application, e.g. single or dual side, vacuum and nipping can be selected for optimum treatment uniformity and minimum impact on the lofty web structure. Various other methods may be employed for contacting a substrate with the treatment composition or compositions in accordance with the invention. For example, a substrate may be printed on by means of print rolls, slot coating or other conventional coating techniques.

In a desirable embodiment, a nonwoven web is treated with compositions and methods of the present invention to improve wettability, absorbency and the fluid intake ability of the web. The treated nonwoven web can be incorporated into a personal care product, such as a surge layer or surge material in a diaper or other personal care product, to provide improved skin dryness. Furthermore, the components of the treatment composition can be applied in separate steps or in one combined step. It should also be understood that the method and hydrophilic surface treatment of nonwoven materials with topical application of surfactants of this invention may incorporate not only multiple surfactants for improved wettability with aqueous fluids (e.g. urine), or to facilitate management of other body fluids (blood, menstrual fluid, feces, etc.), but may also be used to incorporate bioactive compounds and other macromolecules, which may afford biofunctional attributes to the surface treatments of this invention (e.g. antibacterial activity, preservatives, anti-inflammatory, odor control, skin wellness and so forth). For example, a nonwoven web or fibers of the present invention may include optional skin care, odor control and/or antibacterial ingredients.

Desirably, a treatment or coating of the present invention is durable to multiple exposures to an aqueous medium at a temperature in a range of from about 10° C. to about 50° C. Treated nonwoven webs of the present invention may vary in basis weight and/or density and may be applicable to a variety of applications including, but not limited to, components of various personal care and absorbent products, wipers, such as infant wipers and clean room wipers, and so forth.

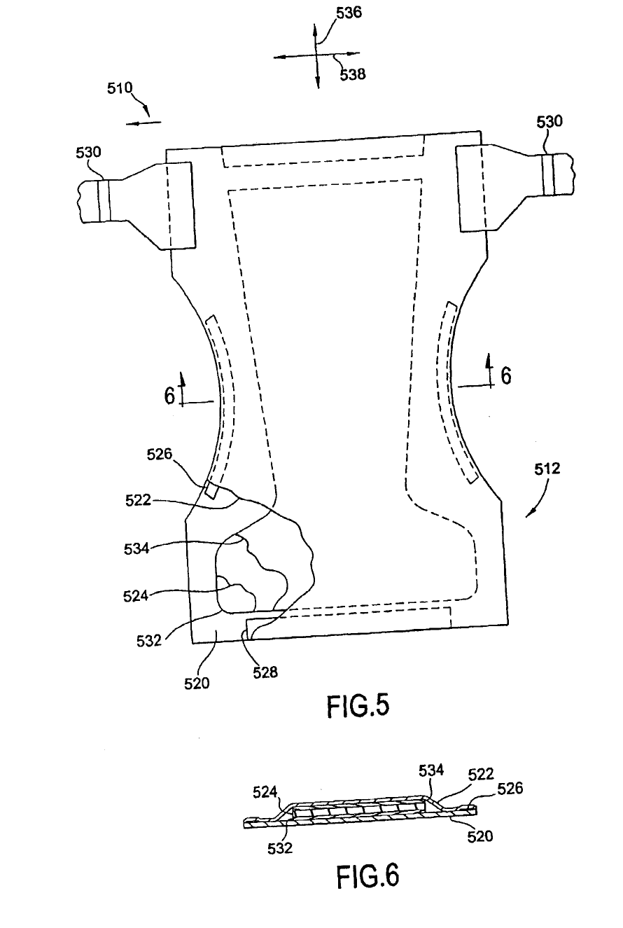

An exemplary absorbent article is illustrated in FIGS. 5 and 6 and includes a vapor permeable backsheet 520, a liquid permeable topsheet 522 positioned in facing relation with the backsheet 520, and an absorbent body or material 524, such as an absorbent pad or the like, which is located between the backsheet 520 and the topsheet 522. The backsheet 520 defines a length and a width which, in the illustrated embodiment, coincide with the length and width of the diaper 10. The absorbent body 524 generally defines a length and width which are less than the length and width of the backsheet 520, respectively. Thus, marginal portions of the diaper 510, such as marginal sections of the backsheet 520, may extend past the terminal edges of the absorbent body 524. In the illustrated embodiments, for example, the backsheet 520 extends outwardly beyond the terminal marginal edges of the absorbent body 524 to form side margins and end margins of the diaper 510. The topsheet 522 is generally coextensive with the backsheet 520 but may optionally cover an area which is larger or smaller than the area of the backsheet 520, as desired. The backsheet 520 and topsheet 522 are intended to face the garment and body of the wearer, respectively, while in use.

Examples of diaper configurations suitable for use in connection with the instant application which may include other diaper components suitable for use on diapers are described in U.S. Pat. No. 4,798,603 issued Jan. 17, 1989, to Meyer et al.; U.S. Pat. No. 5,176,668 issued Jan. 5, 1993, to Bernardin; U.S. Pat. No. 5,176,672 issued Jan. 5, 1993, to Bruemmer et al.; U.S. Pat. No. 5,192,606 issued Mar. 9, 1993, to Proxmire et al., and U.S. Pat. No. 5,509,915 issued Apr. 23, 1996 to Hanson et al., the disclosures of which are herein incorporated by reference in their entirety.

Various woven and nonwoven fabrics can be used to construct the surge management layer 534. For example, the surge management layer 534 may be a layer composed of a meltblown or spunbonded web of synthetic fibers, such as polyolefin fibers. The surge management layer 534 may also, for example, be a bonded-carded-web or an airlaid web composed of natural and synthetic fibers. The bonded-carded-web may, for example, be a thermally bonded web which is bonded using low melt binder fibers, powder or adhesive. The webs can optionally include a mixture of different fibers. Although the layer of surge material may itself be made up of one or more layers of materials, for purposes of this disclosure the surge layer shall be referred to, for descriptive purposes only, as one layer. The surge management layer 534 may be composed of a substantially hydrophobic material, and the hydrophobic material may optionally be treated with a surfactant or otherwise processed to impart a desired level of wettability and hydrophilicity. In a particular embodiment, the surge management layer 534 includes a hydrophilic, nonwoven material having a basis weight of from about 30 to about 120 grams per square meter (gsm).

For example, in a particular embodiment, the surge management layer 534 may comprise a bonded-carded-web, nonwoven fabric which includes bicomponent fibers and which defines an overall basis weight of about 83 grams per square meter. The surge management layer 534 in such a configuration can be a homogeneous blend composed of about 60 weight percent polyethylene/polyester (PE/PET), sheath-core bicomponent fibers which have a fiber denier of about 2 and about 40 weight percent single component polyester is fibers which have a fiber denier of about 3 and which have nominal fiber lengths of from about 3.8 to about 5.08 centimeters. In a particular embodiment, the treatment composition is applied to the surge management layer.

In the illustrated embodiments, the surge management layer 534 is preferably arranged in a direct, contacting liquid communication fashion with the absorbent body 524. The surge management layer 534 may be operably connected to the topsheet 522 with a conventional pattern of adhesive, such as a swirl adhesive pattern. In addition, the surge management layer 534 may be operably connected to the absorbent body 524 with a conventional pattern of adhesive. The amount of adhesive add-on should be sufficient to provide the desired levels of bonding, but should be low enough to avoid excessively restricting the movement of liquid from the topsheet 522, through the surge management layer 534 and into the absorbent body 524.

The absorbent body 524 is desirably positioned in liquid communication with surge management layer 534 to receive liquids released from the surge management layer, and to hold and store the liquid. In the shown embodiments, the surge management layer 534 comprises a separate layer which is positioned, at least in part, over another separate layer comprising the absorbent body 524, thereby forming a dual-layer arrangement. The surge management layer 534 serves to quickly collect and temporarily hold discharged liquids, to transport such liquids from the point of initial contact and spread the liquid to other parts of the surge management layer 534, and then to substantially completely release such liquids into the layer or layers comprising the absorbent body 524.

The surge management layer 534 can be of any desired shape. Suitable shapes include for example, circular, rectangular, triangular, trapezoidal, oblong, dog-boned, hourglass-shaped, or oval. In certain embodiments, for example, the surge management layer can be generally rectangular-shaped. In the illustrated embodiments, the surge management layer 534 is coextensive with the absorbent body 524. Alternatively, the surge management layer 534 may extend over only a part of the absorbent body 524. Where the surge management layer 534 extends only partially along the length of the absorbent body 524, the surge management layer 534 may be selectively positioned anywhere along the absorbent body 524. For example, the surge management layer 534 may function more efficiently when is it is offset toward the front waist section 512 of the garment. The surge management layer 534 may also be approximately centered about the longitudinal center line of the absorbent body 524.

Additional materials suitable for the surge management layer 534 are set forth in U.S. Pat. No. 5,486,166 issued Jan. 23, 1996 in the name of Ellis et al. and entitled “Fibrous Nonwoven Web Surge Layer For Personal Care Absorbent Articles And The Like”; U.S. Pat. No. 5,490,846 issued Feb. 13, 1996 in the name of Ellis et al. and entitled “Improved Surge Management Fibrous Nonwoven Web For Personal Care Absorbent Articles And The Like”; and U.S. Pat. No. 5,364,382 issued Nov. 15, 1994 in the name of Latimer et al. and entitled “Absorbent Structure Having Improved Fluid Surge Management And Product Incorporating Same”, the disclosures of which are hereby incorporated by reference in their entirety.

The present invention also contemplates a disposable absorbent article including a vapor permeable backsheet having a WVTR of at least about 1000 grams/m²/24 hr; a liquid permeable topsheet in facing relation with the backsheet; an absorbent body located between the backsheet and the topsheet, the absorbent body located in one or more regions of the article. Further still, it is desirable for the vapor permeable backsheet to be substantially liquid impermeable. The absorbent article may also be a personal care product, such as a diaper, training pant, absorbent underpant, adult incontinence product, feminine hygiene product, hygiene and absorbent product or the like.

The present invention is further illustrated by the following examples which are representative of the invention although other examples will be apparent to those skilled in the art and are intended to be covered by the claims.

### EXAMPLES

Samples of lofty nonwoven, spunbonded web having a basis weight of about 85 grams per square meter, made of side-by-side polyethylene/polypropylene fibers made in accordance with the methods described in U.S. Pat. No. 5,382,400 issued to Pike et al. and U.S. patent application Ser. No. 10/037,467 previously incorporated by reference above were treated with varying treatment compositions according to the following treatment procedure.

The treatment procedure used to manufacture the examples is generally illustrated in FIG. 7. The lofty, nonwoven spunbonded web 700 described above was forwarded over a first guider roller 710 to a first treatment station 720. The first treatment station 720 consisted of a first foam applicator 724 for applying a treatment solution to one side 702 of the web and a vacuum nozzle 726 for saturating and drawing the treatment solution through the web 700. The first foam applicator included a CFS Laboratory Foam Generator/Controller with a 60-inch parabolic applicator that was obtained from Gaston System, Incorporated of Stanley, N.C. The treatment solutions in Table 2 below consisted of a 10 percent by weight aqueous solution of the components of the treatment solution as specified. At the first treatment station 720 treatment solution was applied to the rough side of the web, that is the side of the web that did not contact the forming wire during formation of the web. The side of the web that contacted the forming wire during web formation is generally smoother.

The web then was forwarded to a second foam treatment station 730. The second treatment station 720 consisted of a second foam applicator 734 for applying a treatment solution to the other side 704 of the web and a nip roll 736 for spreading the treatment solution on the web 700. The web then proceeded over a second guide roll 740 to a pair of nip rolls 750 and 752 before proceeding to a vacuum box 760 and a dryer 770 for removing excess treatment solution and drying the web 700, respectively.

Fluid Intake Rate: Fluid intake rates of treated materials were measured according to a standard test identified as Fluid Strikethrough EDANA 150.1-90 with the exception that the test procedure was modified to use 10 milliliters (ml) of saline instead of 5 milliliters of saline for the results presented in Table 1 below. The test measures the time taken for a known volume of liquid (simulated urine) applied to the surface of a nonwoven test sample in contact with an underlying absorbent pad to pass through the nonwoven sample. In general, a 50 milliliter burette is positioned on a ring stand with the tip inside a funnel. A standard absorbent pad of 5 plies of specified filter paper (482 percent absorbency) is placed on an acrylic glass base plate below the funnel, and a nonwoven sample is placed on top of the absorbent. An acrylic glass strike-through plate 25 millimeter thick and weighing 500 grams is placed over the sample with the cavity centered 5 millimeter below the funnel. The burette is filled with liquid, keeping the funnel closed, and a quantity of the liquid (e.g., 5 ml or 10 ml) is run into the funnel. The 5 ml or 10 ml is allowed to discharge starting a timer which stops when the liquid has penetrated into the pad and fallen below a set of electrodes, and the elapsed time is recorded. The liquid used was Blood Bank Saline, available from Stephens Scientific Co., Catalog No. 8504.

TABLE 1

| Example | | Strikethrough Time (seconds)* | | | | | | | | | |
|---|---|---|---|---|---|---|---|---|---|---|---|
| number | | 1 | 2 | 3 | 4 | 5 | 6 | 7 | 8 | 9 | 10 |
| 1 | side 1 | 6.13 | 5.00 | 3.78 | 3.68 | 3.83 | 3.68 | 3.26 | 2.92 | 2.91 | 2.89 |
| | side 2 | 3.90 | 2.73 | 2.45 | 2.43 | 2.73 | 2.31 | 2.17 | 2.44 | 2.17 | 2.26 |
| A | side 1 | 2.68 | 2.40 | 2.37 | 2.24 | 2.29 | 2.45 | 2.50 | 3.91 | 2.60 | 2.66 |
| | side 2 | 2.55 | 2.36 | 2.46 | 2.20 | 2.33 | 2.29 | 2.35 | 2.32 | 2.48 | 2.73 |
| 2 | side 1 | 1.94 | 2.74 | 2.05 | 2.18 | 1.94 | 2.13 | 2.36 | 2.28 | 2.40 | 2.40 |
| | side 2 | 2.35 | 2.35 | 2.11 | 2.24 | 2.12 | 2.23 | 2.55 | 2.74 | 3.00 | 3.09 |
| B | side 1 | 6.58 | 5.75 | 6.12 | 7.32 | 6.96 | 7.23 | 8.12 | 7.32 | 8.01 | 7.93 |
| | side 2 | 6.43 | 6.72 | 5.98 | 6.56 | 7.26 | 6.88 | 6.91 | 7.24 | 7.05 | 7.50 |

Each example in Table 1 was tested three times on each side, side 1 and side 2. Side 1 was the smooth side of the nonwoven web. The smooth side is the side of the nonwoven web that contacts the forming wire during web formation. Side 2 was the rough side of the web that is opposite the smooth side. The intake times were measured over 10 cycles and the test specimen was dried between 10 milliliter saline insults. The Strikethrough Time data that is presented in Table 1 is an average of the three Strikethrough Times that were measured.

Example 1 of Table 1 was a lofty nonwoven, spunbonded web having a basis weight of about 85 grams per square meter, made of side-by-side polyethylene/polypropylene fibers made in accordance with the methods described above that was treated on each side with a foam of a 10 weight percent solution of a mixture of AHCOVEL, GLUCOPON, MASIL SF-19 combined at a 3:1:1 ratio resulting in a 2 weight percent add-on. Example 2 of Table 1 was the same lofty nonwoven, spunbonded web treated on each side in a bath of a 2 weight percent solution of a mixture of AHCOVEL, GLUCOPON, MASIL SF-19 combined at a 3:1:1 ratio using the dip and squeeze method, also resulting in a 2 weight percent add-on. Comparative Example A of Table 1 was a 85 gsm bonded carded web made from staple polyethylene sheath/poly(ethylene terephthalate) core fibers produced by KoSa of Spartanburg, S.C. treated with a conventional surfactant. This bonded carded web has good wettability and illustrates desirable strikethrough times. Comparative Example B of Table 1 was the same lofty nonwoven, spunbonded web treated on each side with a foam of a 10 weight percent solution of a mixture of AHCOVEL and GLUCOPON combined at a 3:1 ratio resulting in a 2 weight percent add-on and illustrates that the surface treatment with AHCOVEL, GLUCOPON and MASIL SF-19 (Examples 1 and 2) is more beneficial in terms of fluid intake than the two components, AHCOVEL and GLUCOPON. Examples of Table 2 compare the fluid intake performance of spunbonded fabrics treated with AGS (Examples 3-17) with similar fabrics treated with AG (Examples C and D). Table 2 also compares the effect of vacuum on treatment efficiency. The data of Table 2 shows that AGS treatment imparts faster fluid intake than AG treatment on similar fabrics. The data of Table 2 also indicates that the use of vacuum during the foam application process improves treatment uniformity of the fabrics as indicated by faster fluid intake. Alternatively, the application of nipping or pressure to the treated fabrics can have a similar effect as the application of a vacuum to the treated web. It may be desirable to apply both a vacuum and nipping to the treated web as illustrated in FIG. 7.

TABLE 2

| EXAMPLE | Treatment | Treatment | Vacuum | INTAKE TIME (seconds) | |
|---|---|---|---|---|---|
| Number | Composition | Add-on (%) | (inches of water) | Smooth side | Rough side |
| 3 | A:G:S@3:1:1 | 0.5 weight % | 0 | >90 | 6.45 |
| 4 | A:G:S@3:1:1 | 0.5 weight % | 85 | >90 | 4.72 |
| 5 | A:G:S@3:1:1 | 0.5 weight % | 58 | 58.4 | 5.48 |
| 6 | A:G:S@3:1:1 | 0.5 weight % | 36 | 61.2 | 3.03 |
| 7 | A:G:S@3:1:1 | 1.0 weight % | 0 | 71.8 | 3.74 |
| 8 | A:G:S@3:1:1 | 1.0 weight % | 86 | 4.58 | 3.87 |
| 9 | A:G:S@3:1:1 | 1.0 weight % | 68 | 2.63 | 3.33 |
| 10 | A:G:S@3:1:1 | 1.0 weight % | 32 | 2.45 | 2.4 |
| 11 | A:G:S@3:1:1 | 1.5 weight % | 0 | 65.2 | 2.78 |
| 12 | A:G:S@3:1:1 | 1.5 weight % | 88 | 2.55 | 2.37 |
| 13 | A:G:S@3:1:1 | 1.5 weight % | 66 | 2.65 | 2.49 |
| 14 | A:G:S@3:1:1 | 1.5 weight % | 34 | 1.53 | 1.21 |
| 15 | A:G:S@3:1:1 | 2.0 weight % | 0 | 5.51 | 1.49 |
| 16 | A:G:S@3:1:1 | 2.0 weight % | 88 | 1.21 | 1.34 |
| 17 | A:G:S@3:1:1 | 2.0 weight % | 66 | 1.51 | 1.26 |
| C | A:G @ 3:1 | 2.0 weight % | 0 | 6.53 | 5.87 |
| D | A:G @ 3:1 | 2.0 weight % | 88 | 6.72 | 5.85 |

The test data indicates that nonwoven webs treated with treatment compositions of the present invention, that is treatment compositions that include ethoxylated hydrogenated castor oil, sorbitan monooleate, an ethoxylated polyalkyl siloxane, and an alkyl polyglycoside or a derivative of an alkyl polyglycoside (Examples 15 and 16), provide superior wettability compared to similar nonwoven webs treated with only ethoxylated hydrogenated castor oil, sorbitan monooleate, and an alkyl polyglycoside or a derivative of an alkyl polyglycoside (Comparative Examples A and B).

Thus, in accordance with the invention, there has been provided an improved treatment composition, process and resulting treated nonwovens that provide one or more of the benefits described above. While the invention has been illustrated by specific embodiments, it is not limited thereto and is intended to cover all equivalents as come within the broad scope of the claims.

We claim:

1. An aqueous treatment composition for treating a substrate, the aqueous treatment composition comprising:
from about 50 weight percent to about 95 weight percent of water; and
at least about 5 weight percent of a mixture of additives comprising
from about 4 parts to about 10 parts by weight of a first additive that includes a blend of ethoxylated hydrogenated castor oil and sorbitan monooleate;
from about 1 to about 4 parts by weight of a second additive that is an alkyl polyglycoside or a derivative of an alkyl polyglycoside; and
from about 1 to about 4 parts by weight of a third additive that is an ethoxylated polyalkyl siloxane.

2. The aqueous treatment composition of claim 1, wherein the aqueous treatment composition comprises from about 70 weight percent to about 95 weight percent of water.

3. The aqueous treatment composition of claim 1, wherein the aqueous treatment composition comprises at least about 7 weight percent of the mixture of additives.

4. The aqueous treatment composition of claim 1, wherein the mixture of additives comprises
from about 4 parts to about 8 parts by weight of the first additive;
from about 1 to about 3 parts by weight of the second additive; and
from about 1 to about 3 parts by weight of the third additive.

5. The aqueous treatment composition of claim 1, wherein the mixture of additives comprises from about 2 to about 4 parts by weight of the first additive, from about 1 to about 2 parts by weight of the second additive and about 1 part by weight of the third additive.

6. The aqueous treatment composition of claim 1, wherein the mixture of additives comprises about 3 parts by weight of the first additive, about 1 part by weight of the second additive and about 1 part by weight of the third additive.

7. The aqueous treatment composition of claim 1, wherein the alkyl polyglycoside or the derivative of an alkyl polyglycoside is an octylpolyglycoside.

8. The aqueous treatment composition of claim 1, wherein the mixture of additives consists essentially of from about 2 to about 4 parts by weight of the first additive, from about 1 to about 2 parts by weight of the second additive and about 1 part by weight of the third additive.

9. The aqueous treatment composition of claim 1, wherein the aqueous treatment composition is a foamed treatment composition.

10. An aqueous treatment composition for a substrate, the aqueous treatment composition comprising:
from about 70 weight percent to about 95 weight percent of water;
from about 1.5 weight percent to about 15 weight percent of sorbitan monooleate;
from about 1 weight percent to about 10 weight percent of an ethoxylated, hydrogenated castor oil;
from about 0.5 weight percent to about 5 weight percent of an alkyl polyglycoside or a derivative of an alkyl polyglycoside; and
from about 1 weight percent to about 10 weight percent of an ethoxylated polyalkyl siloxane.

11. The aqueous treatment composition of claim 10, wherein the aqueous treatment composition comprises from about 80 weight percent to about 95 weight percent of water.

12. The aqueous treatment composition of claim 10, wherein the aqueous treatment composition comprises at least about 3 weight percent of sorbitan monooleate, at least about 2 weight percent of the ethoxylated, hydrogenated castor oil, at least about 1 weight percent of the alkyl polyglycoside, and at least about 2 weight percent of the ethoxylated polyalkyl siloxane.

13. The aqueous treatment composition of claim 10, wherein from about 80 weight percent to about 95 weight percent of water;
from about 2 weight percent to about 10 weight percent of sorbitan monooleate;
from about 1.5 weight percent to about 10 weight percent of an ethoxylated, hydrogenated castor oil;
from about 0.75 weight percent to about 5 weight percent of an alkyl polyglycoside or a derivative of an alkyl polyglycoside; and
from about 1 weight percent to about 5 weight percent of an ethoxylated polyalkyl siloxane.

14. Fibers comprising a surface treated with a surfactant mixture comprising an ethoxylated, hydrogenated castor oil; sorbitan monooleate; an ethoxylated polyalkyl siloxane; and an alkyl polyglycoside or a derivative of an alkyl polyglycoside.

15. The fibers of claim 14, wherein the fibers are multicomponent fibers.

16. The fibers of claim 14, wherein the fibers are bicomponent fibers.

17. The fibers of claim 14, wherein the fibers are bicomponent fibers comprising a polyethylene component and a polypropylene component in a side-by-side configuration.

18. A porous thermoplastic substrate treated with an ethoxylated, hydrogenated castor oil; sorbitan monooleate; an ethoxylated polyalkyl siloxane; and an alkyl polyglycoside or a derivative of an alkyl polyglycoside.

19. The porous thermoplastic substrate of claim 18, wherein the porous thermoplastic substrate is a lofty nonwoven fabric.

20. The porous thermoplastic substrate of claim 18, wherein the porous thermoplastic substrate is a lofty nonwoven fabric that comprises multicomponent fibers.

21. The porous thermoplastic substrate of claim 18, wherein the porous thermoplastic substrate is a lofty nonwoven fabric that comprises bicomponent fibers.

22. The porous thermoplastic substrate of claim 18, wherein the porous thermoplastic substrate is a lofty nonwoven fabric that comprises bicomponent fibers comprising a polyethylene component and a polypropylene component in a side-by-side configuration.

23. A personal care article comprising the thermoplastic substrate of claim 18.

24. A health care article comprising the thermoplastic substrate of claim 18.

25. An absorbent article comprising the thermoplastic substrate of claim 18.

26. A method of treating a nonwoven substrate comprising contacting a substrate with a composition that comprises a mixture of additives comprising:
from about 2 parts to about 10 parts of an ethoxylated, hydrogenated castor oil;
from about 2 parts to about 10 parts of sorbitan monooleate;
from about 1 part to about 5 parts of a an alkyl polyglycoside or a derivative of an alkyl polyglycoside; and
from about 1 part to about 10 parts of an ethoxylated polyalkyl siloxane.

27. The method of claim 26, wherein the mixture of additives in included in an aqueous treatment composition that comprises from about 50 weight percent to about 95 weight percent of water.

28. The method of claim 1, wherein the mixture of additives in included in an aqueous treatment composition comprises from about 80 weight percent to about 90 weight percent of water.

29. The aqueous treatment composition of claim 26, wherein the mixture of additives comprises:
from about 3 parts to about 6 parts of an ethoxylated, hydrogenated castor oil;
from about 2 parts to about 5 parts of sorbitan monooleate;
from about 1 part to about 2 parts of an alkyl polyglycoside or a derivative of an alkyl polyglycoside; and
from about 1 parts to about 4 parts of an ethoxylated polyalkyl siloxane.

30. The aqueous treatment composition of claim 26, wherein the mixture of additives comprises:
from about 3 parts to about 6 parts of an ethoxylated, hydrogenated castor oil;
from about 2.5 parts to about 5 parts of sorbitan monooleate;
from about 1 part to about 2 parts of an alkyl polyglycoside or a derivative of an alkyl polyglycoside; and
from about 2 parts to about 4 parts of an ethoxylated polyalkyl siloxane.

31. A method of enhanced fluid handling properties to a lofty bicomponent nonwoven substrate, the method comprising contacting a lofty bicomponent nonwoven substrate with an aqueous treatment composition that comprises:
from about 50 weight percent to about 95 weight percent of water;
from about 1.5 weight percent to about 20 weight percent of sorbitan monooleate;
from about 1.5 weight percent to about 15 weight percent of an ethoxylated, hydrogenated castor oil;
from about 0.75 weight percent to about 7.5 weight percent of an alkyl polyglycoside or a derivative of an alkyl polyglycoside; and
from about 1 weight percent to about 10 weight percent of an ethoxylated polyalkyl siloxane.

32. The method of claim 31, wherein the aqueous treatment composition comprises
from about 80 weight percent to about 95 weight percent of water;
from about 1.5 weight percent to about 6 weight percent of sorbitan monooleate;
from about 1.5 weight percent to about 6 weight percent of an ethoxylated, hydrogenated castor oil;
from about 0.75 weight percent to about 3 weight percent of an alkyl polyglycoside or a derivative of an alkyl polyglycoside; and
from about 1 weight percent to about 5 weight percent of an ethoxylated polyalkyl siloxane.

33. The method of claim 31, wherein the aqueous treatment composition is applied as a foam.

34. The method of claim 31, wherein the aqueous treatment is applied uniformly to the lofty bicomponent nonwoven substrate so that a durable hydrophilic character is imparted to the lofty bicomponent nonwoven substrate.

35. The method of claim 31, wherein the aqueous treatment is applied to one side of the lofty bicomponent nonwoven substrate.

36. The method of claim 31, wherein the aqueous treatment is applied to both sides of the lofty bicomponent nonwoven substrate.

37. An aqueous treatment composition that comprises water and a mixture of additives that consists essentially of from about 2 to about 4 parts by weight of the first additive, from about 1 to about 2 parts by weight of the second additive and about 1 part by weight of the third additive
